(19) United States
(12) Patent Application Publication
(10) Pub. No.: US 2022/0048535 A1
(43) Pub. Date: Feb. 17, 2022

(54) Generating Goal States for Prioritizing Path Planning

(71) Applicant: Woven Planet North America, Inc., Los Altos, CA (US)

(72) Inventors: Moritz Niendorf, San Francisco, CA (US); Sammy Omari, Los Altos, CA (US)

(73) Assignee: Woven Planet North America, Inc., Los Altos, CA (US)

(21) Appl. No.: 16/991,773

(22) Filed: Aug. 12, 2020

(51) Int. Cl. B60W 60/00; G05D 1/02; G05D 1/00; B60W 30/095; G01C 21/34; G06N 20/00; G06N 5/04

(52) U.S. Cl. CPC B60W 60/0011; G05D 1/0221; G05D 1/0214; G05D 1/0088; B60W 30/0956; G01S 17/931; G01C 21/3407; B60W 60/0013; B60W 60/0015; G06N 20/00; G06N 5/04; G01C 21/3461

(57) ABSTRACT

In one embodiment, a method includes receiving environment data associated with an environment detected by a vehicle, generating goal states of the environment for the vehicle by using observed driving data associated with the environment, wherein each goal state corresponds to a region that the vehicle is capable of navigating through in the environment, generating candidate trajectories for the vehicle based on at least the goal states of the environment, wherein each candidate trajectory is associated with at least one goal state, assigning candidate values to the candidate trajectories based on the observed driving data, and selecting a candidate trajectory associated with at least one goal state from the candidate trajectories for the vehicle to navigate through the environment based on the candidate values.

### BACKGROUND

Autonomous vehicles rely on effective and efficient path planning to drive in urban environments with the safest, most convenient, and most computationally efficient vehicle-trajectories. A vehicle-trajectory is a sequence of states visited by the vehicle, parameterized by time and velocity. Trajectory planning or trajectory generation is the real-time planning of a vehicle's move from one feasible state to the next, satisfying the vehicle's kinematic limits based on its dynamics and as constrained by the navigation mode. For example, trajectory planning or generation must deal with complex intersections, widely varying road surface conditions, radically changing weather conditions, moving agents, widely fluctuating types and sizes of objects, dramatically different road types, severely changing lighting conditions, missing or confusing lane markings, etc. Finding a potential vehicle-trajectory is complicated as the path planning system needs to identify all the static and moving agents and make sure the potential vehicle-trajectory bypass these agents. In addition, there are a vast number of possible trajectories that a vehicle can take in a complex driving scenario. Therefore, path planning also needs to effectively prune these trajectories for the complex driving scenario.

### BRIEF DESCRIPTION OF THE DRAWINGS

FIG. 1A illustrates an example complex driving scenario where another vehicle is cutting into the driving lane of a vehicle.

FIG. 1B illustrates an example complex driving scenario where there are multiple agents with environment constraints.

FIG. 2 illustrates an example architecture for path planning.

FIG. 3 illustrates an example workflow for goal stage generation for a vehicle.

FIG. 4 illustrates example goal states for a vehicle surrounded by multiple other vehicles.

FIG. 5 illustrates an example trajectory generation based on goal states.

FIG. 6 illustrates an example selected trajectory.

FIG. 7A illustrates an example training data of lane changing.

FIG. 7B illustrates an example ground truth associated with the example training data in FIG. 7A.

FIG. 7C illustrates an example conversion of the ground truth in FIG. 7B to a processable input to a machine-learning model.

FIG. 7D illustrates an example optimization of a machine-learning model.

FIG. 8 illustrates an example of a method for determining a trajectory using goal states.

FIG. 9 illustrates an example block diagram of a transportation management environment for matching ride requestors with autonomous vehicles.

FIG. 10 illustrates an example of a processing pipeline for autonomous driving.

FIG. 11 illustrates an example of a computing system.

### DESCRIPTION OF EXAMPLE EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. In addition, the embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

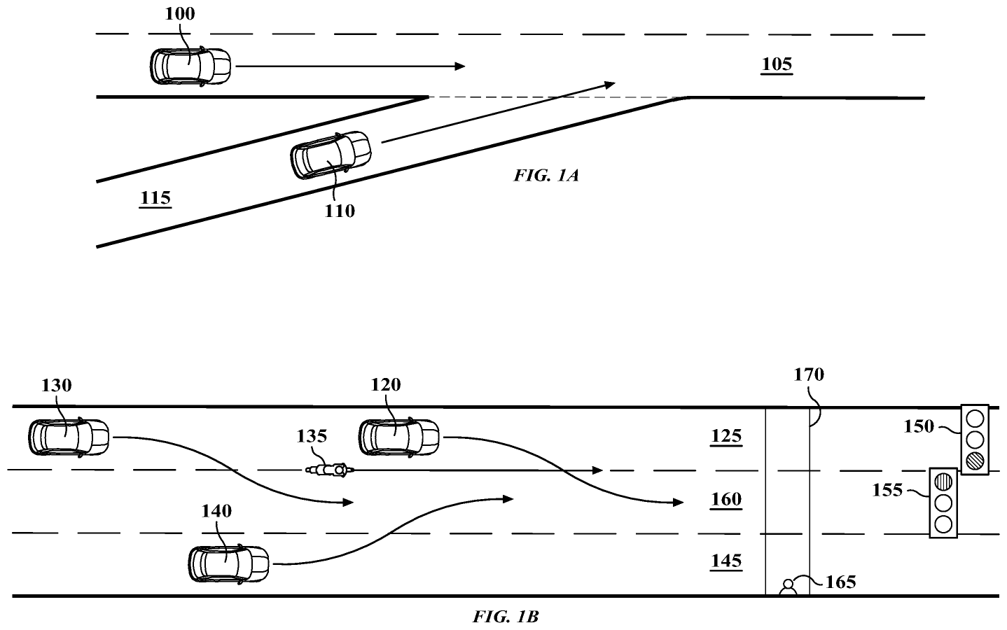

Path planning may involve determining a potential trajectory to get a vehicle from a location to another location based on movement and environmental constraints. As the complexity of the driving scenario increases, e.g., lane changing, trajectory determination may become a more and more challenging problem. However, path planning may need to take into account such complex scenarios to avoid suboptimal driving (e.g., humans change lanes to avoid a slow truck, avoid being too close to a car parked on the shoulder of a highway, etc.). Therefore, how to effectively determine a potential trajectory while considering complex scenarios is important in path planning. FIGS. 1A-1B illustrate example complex driving scenarios that pose challenges to trajectory determination. FIG. 1A illustrates an example complex driving scenario where another vehicle is cutting into the driving lane of a vehicle. In FIG. 1A, vehicle 100 may be driving in lane 105 and under path planning to evaluate the complex driving scenario. Another vehicle 110 may be approaching from lane 115 that intersects with lane 110. The driving scenario for vehicle 100 is complex since the trajectory for vehicle 100 for the next few seconds may need to consider how to safely navigate this complex driving scenario while taking into account the driving behavior of vehicle 110. Vehicle 100 may need to slow down, for which the possible potential trajectories may be much more than just driving in a straight lane without any intersecting lane or any other vehicle. FIG. 1B illustrates an example complex driving scenario where there are multiple agents with environment constraints. In FIG. 1B, vehicle 120 may be under path planning to evaluate the complex driving scenario. Vehicle 120 may be driving in lane 125 being followed by vehicle 130. There may be a motorist 135 following vehicle 120 on the right side. Another vehicle 140 may be driving in another lane 145. There may be traffic lights 150 governing lane 125 and traffic lights 155 governing lane 160 in a foreseeable distance. In addition, a pedestrian 165 may be waiting to cross the street via the pedestrian lane 170. As indicated in FIG. 1B, vehicle 120, vehicle 130, and vehicle 140 may be all planning to change lanes to lane 160. FIG. 1B illustrates a real-world complex scenario for vehicle 120 to plan a trajectory to lane 160. The planning may need to consider how to achieve the objective of safely changing lanes while taking into account the traffic lights and the respective behaviors of the other vehicles, motorists, and the pedestrian. For path planning involving the aforementioned complex scenarios, one may use hand-engineered rules taking into account such scenarios to determine possible trajectories. However, FIG. 1A and FIG. 1B are just two examples of complex scenarios in path planning. In reality, there may exist a tremendous amount of complex scenarios. The sheer amount of complex scenarios may make it impossible for one to design and use hand-engineer rules to account for all of these different complex scenarios.

To address the aforementioned problem of considering various complex scenarios such as lane changing in path planning, the embodiments disclosed herein may generate candidate goal states associated with different complex scenarios and then explore trajectories for accomplishing those goal states. In particular embodiments, a goal state may be a high-dimensional (e.g., 3D or even higher dimension) spatial-temporal volume indicating an objective of a trajectory of the vehicle (e.g., staying in the same lane, changing lanes, merging ahead of another vehicle in front, etc.) over a future time period. Goal states may help prioritize path planning and may be particularly effective for complex scenarios such as lane changing. The embodiments disclosed herein may compute candidate trajectories for a few goal states and further determine the final trajectory from these candidate trajectories for path planning. One way to generate goal states may be to use heuristics. However, writing heuristics to account for any real-world scenarios may be difficult to scale and not effective. Instead, the embodiments disclosed herein may leverage observed driving data (e.g., from human driving behavior) to determine the goal states. The embodiments disclosed herein may use a machine-learning model to automatically predict possible goal states indicating objectives of trajectories of the human-driving vehicles over a future time period with the current driving scenario. The computing system may then take those possible goal states predicted by the machine-learning model into account when figuring out a trajectory for a vehicle. Since there are concrete goal states corresponding to different scenarios that have been predicted by the machine-learning model, the computing system may complete its task of determining the best trajectory effectively and efficiently in the real-world driving environment.

In particular embodiments, a computing system of a vehicle may receive environment data associated with an environment detected by the vehicle. The computing system may generate one or more goal states of the environment for the vehicle by using observed driving data associated with the environment. In particular embodiments, each goal state of the one or more goal states may correspond to a region that the vehicle is capable of navigating through in the environment. The computing system may generate a plurality of candidate traj ectories for the vehicle based on at least the one or more goal states of the environment. Each candidate trajectory of the plurality of candidate trajectories may be associated with at least one goal state of the one or more goal states. Based on the observed driving data, the computing system may assign candidate values to the plurality candidate trajectories. The computing system may, based on the candidate values, further select a candidate trajectory associated with at least one goal state from the plurality of candidate trajectories for the vehicle to navigate through the environment.

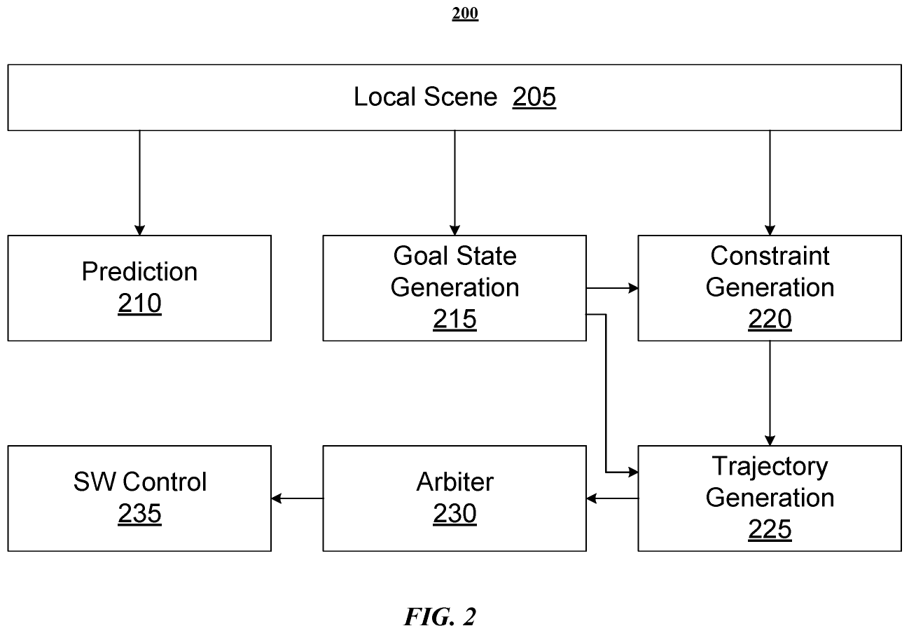

FIG. 2 illustrates an example architecture for path planning. The architecture may be based on different components comprising local scene 205, a prediction module 210, goal state generation 215, constraint generation 220, trajectory generation 225, an arbiter 230, and software (SW) control 240. The architecture may be used to generate and evaluate not only geometric paths but also paths with geometry and velocity. In particular embodiments, path planning may be based on local scene 205, which may comprise environment data associated with an environment detected by a vehicle. The environment data may comprise information comprising one or more of distances between the vehicle and agents around the vehicle in the environment, lane boundaries associated with the environment, velocities of the vehicle and the agents, driving directions of the vehicle and the agents, yield relationships between the vehicle and the agents, locations of the vehicle and the agents, positional relationship (e.g., adjacent, ahead, adjacent ahead, etc.) between the vehicle and the agents, cost associated with potential lane changing, and the like. In particular embodiments, the computing system may generate a raster of the environment based on the environment data. Accordingly, generating the one or more goal states of the environment for the vehicle may be further based on the raster of the environment. The raster may be based on the environment at a current time. The raster may be also based on a prediction of the environment at a future time since the computing system may predict how agents will move in different driving scenarios by using the observed driving data. As an example and not by way of limitation, the computing system may generate the raster of the environment based on the environment data by rasterizing one or more top-down images of the vehicle and agents around the vehicle in the environment. In particular embodiments, the prediction module 210 may predict the status of each agent associated with the vehicle in a future time based on the local scene 205. As an example and not by way of limitation, the predicted status of each agent may comprise a predicted trajectory. The predictions may be cast back to the local scene 205 to enrich the information of the environment.

In particular embodiments, the local scene 205 may be provided for goal state generation 215. Goal states may correspond to discrete actions. A goal state may be represented as a high-dimensional (e.g., 3D) spatial-temporal volume indicating an objective region/location of a trajectory of the vehicle (e.g., staying in the same lane, changing lanes, merging ahead of another vehicle in front, etc.) that the trajectory is meant to achieve over a future time period. As an example and not by way of limitation, one goal state may correspond to a discrete action of a vehicle merging into the gap between two vehicles in an adjacent lane. For complex driving scenarios exemplified in FIG. 1B, determining explicit goal states may be challenging as the number of specific goal states or combinations may get very large. To effectively deal with this challenge, the embodiments disclosed herein may use observed driving data to predict what may be the best or most promising goal states. In particular embodiments, a machine-learning model may be learned from the observed driving data about what humans usually do in certain situations, propose a set of potential goal states, and evaluate the probability of success for each potential goal state.

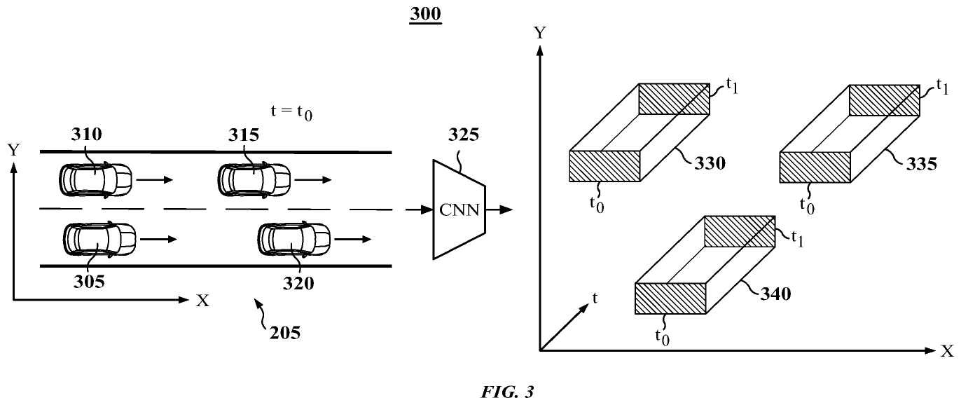

FIG. 3 illustrates an example workflow 300 for goal stage generation 215 for a vehicle. As an example and not by way of limitation, the local scene 205 may comprise two-dimensional (2D) rasterized data from a top-down image of a vehicle 305 and its associated environment at time to. The associated environment may comprise three other vehicles, vehicle 310, vehicle 315, and vehicle 320. The 2D rasterized data at time t0 may be processed by the machine-learning model. Alternatively, the computing system may determine predictions of how agents will move and generate a tensor rasterizing the probability heat map at each point in time. Such tensor may be the input to the machine-learning model. As an example and not by way of limitation, the machine-learning model may be based on convolutional neural networks (CNN) 325. The CNN 325 may output the goal states, each of which may be a 3D spatial-temporal volume with probabilities indicating objective regions/locations of trajectories of vehicle 305 that the trajectories are meant to achieve at different time. As illustrated in FIG. 3, there may be three goal states, i.e., goal state 330, goal state 335, and goal state 340. In particular embodiments, goal state 330 may correspond to the gap between vehicle 310 and vehicle 315. Goal state 330 may indicate the gap variation spatially from to to ti. Goal state 335 may correspond to the space in front of vehicle 315. Goal state 335 may indicate the space variation spatially from to to ti. Goal state 340 may correspond to the gap between vehicle 305 and vehicle 320. Goal state 340 may indicate the gap variation spatially from to to ti. In particular embodiments, the one or more goal states may represent at least one of an intermediate or a terminal goal state. The intermediate goal state can be used to reach the terminal goal state. As an example and not by way of limitation, each of goal state 330, goal state 335, and goal state 340 at time ti may be considered as a terminal goal state. A goal state may also comprise one or more intermediate goal states. As an example and not by way of limitation, each of goal state 330, goal state 335, and goal state 340 between t₀ and t₁ may be considered as intermediate goal states.

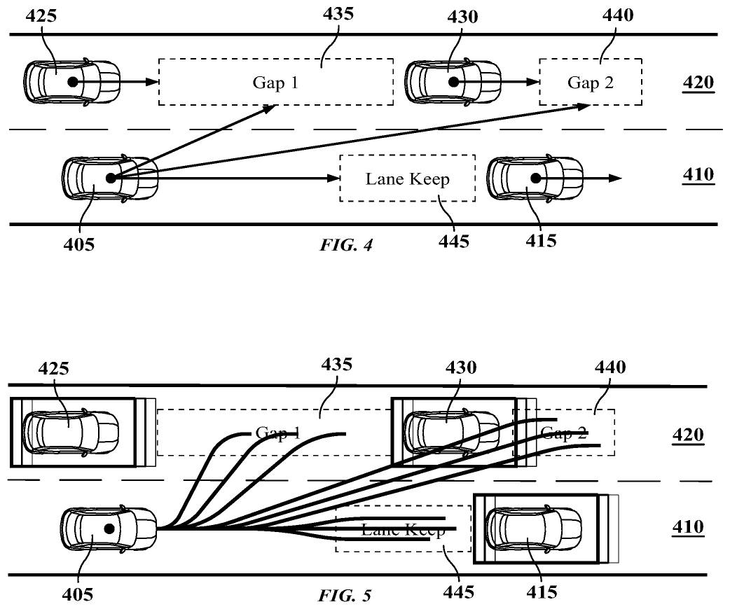

FIG. 4 illustrates example goal states for a vehicle surrounded by multiple other vehicles. In FIG. 4, vehicle 405 may be driving in lane 410. Vehicle 415 may be in front of vehicle 405. In an adjacent lane 420, there may be two other vehicles, i.e., vehicle 425 and vehicle 430. The computing system may have generated three goal states for vehicle 405. The three goal states may correspond to changing lane to the first gap (i.e., gap 1 435), changing lane to the second gap (i.e., gap 2 440), and keeping driving in the current lane (i.e., lane keep 445).

In particular embodiments, constraint generation 220 may be responsible for determining driving constraints associated with the environment. Sometimes constraint generation 220 may be conditioned on goal state generation 215. Constraints may comprise both global and conditional constraints where some global constraints may be independent of the specific goal states and some conditional constraints may be conditioned on the goal state. The computing system may determine one or more global driving constraints based on the environment data. As an example and not by way of limitation, lane boundaries or agents that are not directly interacting with a lane-changing vehicle may be independent of the lane change the vehicle actually performs. As a result, these lane boundaries or agents may be determined as global constraints. In particular embodiments, certain constraints, e.g., the reaction of a vehicle of a goal state may be conditioned on that goal state, leading to a conditional constraint that is specific to that goal state. The computing system may determine one or more conditional driving constraints for each of the one or more goal states. As an example and not by way of limitation, in FIG. 4, a goal state may involve vehicle 405 entering a gap between two vehicles, i.e., vehicle 425 and vehicle 430, in the adjacent lane 420. The corresponding constraints may specify that the lead vehicle 430 may likely maintain its speed and the rear vehicle 425 may likely slowdown in response to vehicle 405 cutting in. If another goal state involves vehicle 405 staying in its own lane 410, the corresponding constraints may indicate that the two adjacent vehicles may likely maintain their respective speed/trajectories.

In particular embodiments, the computing system may down select the initially generated goal states as the number of these goal states may be too large considering computational efficiency. The computing system may down select one or more goal states from the generated one or more goal states based on a desired computational efficiency associated with the computing system. As an example and not by way of limitation, the down selection may be in the order of 10s. In particular embodiments, there may be different approaches to down select the goal states. As an example and not by way of limitation, one may write simple heuristic algorithms to do the down selection. For example, for lane changing, goal states corresponding to any gap larger than five seconds and attainable up to a hundred meters ahead of a vehicle may be selected as reasonable goal states to explore. If there are more conflicts or interactions between a vehicle under path planning with other agents in the environment, one may use more sophisticated algorithms in terms of heuristics to down select goal states.

In particular embodiments, the computing system may jointly generate goal states, generate predictions for other agents, and down-select the goal states. The computing system may process the generated one or more goal states using another machine-learning model. The computing system may then determine a predetermined number of goal states by the machine-learning model, e.g., based on the desired computational efficiency. As an example and not by way of limitation, the machine-learning model may output a maximum number (e.g., 5) goal states. Each goal state may be associated with an evolution of the environment comprising one or more agents. Based on the evolution of the driving environment, the computing system may predict a probability heat map for the one or more agents. As an example and not by way of limitation, for an agent in the local scene 205, the computing system may predict where the agent is most likely going to be in that scene at different time. In other words, if there are five tensors indicating five goal states, for each of those goal states, there may be a corresponding tensor informing what the future or what the predicted agents' positions may be for that given goal state. The computing system may jointly generate goal states and predictions within a single tensor. In particular embodiments, the computing system may further select the one or more goal states from the generated goal states based on the probability heat map. As an example and not by way of limitation, e.g., the computing system may select 5 from 30 goal states to then only compute trajectories for these 5 goal states.

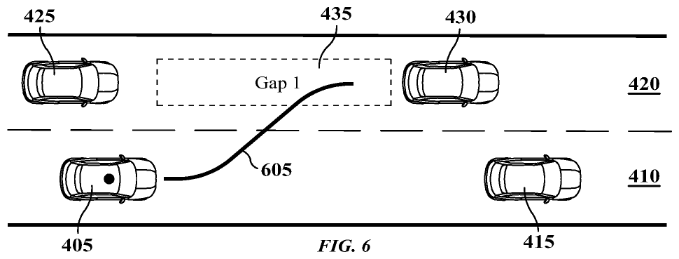

FIG. 5 illustrates an example trajectory generation based on goal states. Once these down-selected goal states are identified, the computing system may pass them together with previously determined constraints to trajectory generation 225. For a goal state, the generated trajectories may need to satisfy both global constraints and conditional constraints associated with that goal state. In particular embodiments, assigning a candidate value of the candidate values to each of the plurality candidate trajectories may be based on at least one of the one or more global driving constraints and the one or more conditional driving constraints. As an example and not by way of limitation, for the goal state 435 in FIG. 4, the generated trajectories may need to end up ahead of vehicle 425 and behind vehicle 430. Note that the boxes surrounding vehicle 415, vehicle 425, and vehicle 430 indicate the constraints associated with each vehicle. In trajectory generation 225, the computing system may use these goal states to inform the generation of many candidate trajectories, which tend to satisfy these goal states or end up in these goal states. The computing system may compute, e.g., up to 500,000 total trajectories, and distribute them across these different goal states. The computing system may further compute good trajectories for each of these goal states. In particular embodiments, a good trajectory may be a trajectory that takes into account the global and conditional constraints and provides a combination of safety, comfort, cost, and other qualities. The computing system may assign certain values to each of these qualities and use them to assess whether a trajectory is a good trajectory. As illustrated in FIG. 5, the computing system may generate a plurality of candidate trajectories for the three goal states determined in FIG. 4. The three goal states may correspond to changing to the first gap 435, changing to the second gap 440, and keeping driving in the current lane 445. The plurality of candidate trajectories may be distributed over these three goal states. The computing system may also determine one or more respective characteristics for each of the plurality of candidate trajectories. As an example and not by way of limitation, the characteristics may comprise one or more of a distance of a candidate trajectory to an obstacle (how close they get to obstacles), an acceleration associated with a candidate trajectory (how much acceleration they incur), comfort characteristics associated with a candidate trajectory, or safety characteristics associated with a candidate trajectory, and the like. The trajectories together with their characteristics may be passed to the arbiter 230.

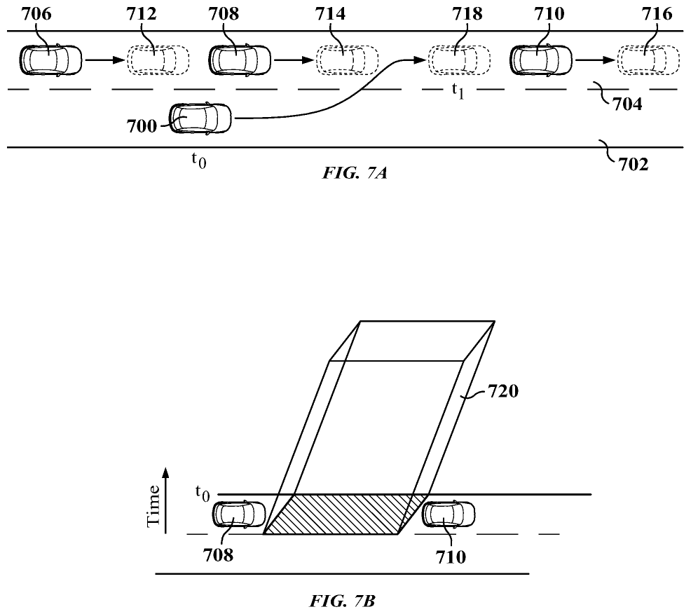

FIG. 6 illustrates an example selected trajectory. The arbiter 230 may take into account information about the utility of generated trajectories ending up in certain goal states and/or characteristics of trajectories themselves to rank these trajectories for further down selection. Accordingly, assigning candidate values to the plurality of candidate trajectories may comprise calculating a candidate value for each of the plurality of candidate trajectories based on the one or more respective characteristics and the at least one goal state associated with the candidate trajectory. In particular embodiments, the arbiter 230 may rank the plurality of candidate trajectories based on their respective candidate values. The arbiter 230 may further select a top-ranked candidate trajectory from the plurality of candidate trajectories as the trajectory for the vehicle to navigate through the environment. As an example and not by way of limitation, a lane-change goal state may be better than ending up in a lane-keep goal state. The down selection of trajectories may consider both the goal states and the characteristics of the trajectories. As illustrated in FIG. 6, the computing system may determine goal state 435 may be the best among all three goal states and among the trajectories that end up in goal state 435, trajectory 605 may be the best trajectory. In alternative embodiments, goal state 435 may be desirable but all the trajectories that reach goal state 435 may be very uncomfortable and there may be still a lot of time left before vehicle 405 actually needs to be in lane. As a result, the arbiter 230 may determine a trajectory corresponding to the lane-keep goal state 445.

In particular embodiments, generating the one or more goal states of the environment for the vehicle may be based on a machine-learning model. The machine-learning model may be trained based on a plurality of training data indicative of driving behaviors. The plurality of training data indicative of driving behaviors may comprise captured sensor data comprising at least one of images, videos, LiDAR point clouds, radar signals, or any combination thereof. Taking lane changing as an example, the training data may be generated by people manually annotating driving data, by simulation tests of driving data, or by automatic analysis of the driving data to identify instances where a lane change happened. Specifically, there may be different levels of scale that the computing system may leverage the training data. One level of scale may be sensor data collected from vehicles, in which drivers may be asked to perform lane changes. The drivers may help record when they initiated the lane changes and when they completed them. A higher level of scale may be automated detection in the driving data where lane changes have happened by checking features such as turn signals or lateral movements. The level of scale grows when the level of automation goes up.

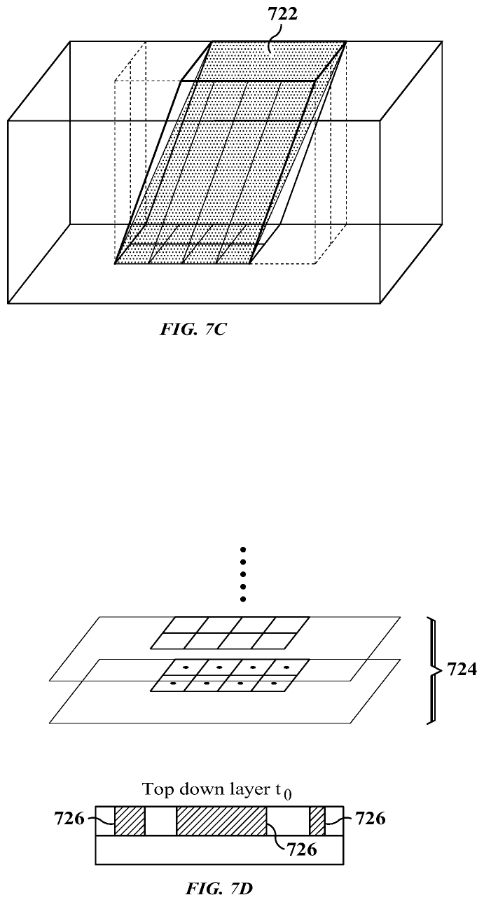

FIG. 7A illustrates an example training data of lane changing. In FIG. 7A, vehicle 700 may be changing lane from lane 702 at time to to lane 704 at time ti. There may be three vehicles, vehicle 706, vehicle 708, and vehicle 710 driving in lane 704. At time t₁, the three vehicles may be at location 712, location 714, and location 716, respectively. At time t₁, vehicle 700 may be at location 718. As can be seen, vehicle 708 and vehicle 710 may have maintained the gap between them, allowing vehicle 700 to change lane to location 718.

FIG. 7B illustrates an example ground truth associated with the example training data in FIG. 7A. In particular embodiments, to generate the ground truth for the example in FIG. 7A, the computing system may track how the gap between vehicle 708 and vehicle 710 changed over time from the time where the lane change started until completion. The tracked changes may form the ground truth, which is a 3D volume 720 as indicated in FIG. 7B. In other words, each training data is associated with a ground truth, which may be a 3D volume indicative of changes of driving behavior over a time period.

FIG. 7C illustrates an example conversion of the ground truth 720 in FIG. 7B to a processable input to a machine-learning model. As illustrated in FIG. 7C, the ground truth 720 in FIG. 7B may be expanded in both space and time corresponding how the gap between vehicle 708 and vehicle 710 evolved over time. The expanded ground truth may comprise a plurality of voxels. As illustrated in FIG. 7C, the marked voxels 722 may be each associated with a value. As an example and not by way of limitation, when the voxel is black it may have the value of one and when the voxel is clear it may have the value of zero. Such input may be understandable by the convolutional neural networks (CNN 325) of the machine-learning model.

The training data together with the converted ground truth in FIG. 7C may be then fed into the CNN 325 for optimization. In particular embodiments, the optimization may use different approaches. FIG. 7D illustrates an example optimization of a machine-learning model. In one embodiment, the CNN 325 may predict a predetermined number of polygons for a 2D spatial output corresponding to the environment at a discrete time within the time period. Each polygon may be associated with a probability. As an example and not by way of limitation, the top part of FIG. 7D indicates that there are several 2D spatial outputs 724 (i.e., slices) whereas the bottom part of FIG. 7D illustrates three polygons 726 at a discrete time (i.e., to) for one 2D spatial output 724. The probability associated with each polygon 726 may indicate whether the polygon 726 is a correct gap, i.e., a vehicle actually drove into. The computing system may compare the 2D spatial output 724 with a corresponding 2D spatial data (i.e., a corresponding slice) in the ground truth 720 at the discrete time. The computing system may then identify a correct polygon 726 from the predicted polygons 726. Consequently, optimizing the machine-learning model may be based on maximizing the probability of the correct polygon 726 and minimizing the probabilities of the remaining predicted polygons 726. As an example and not by way of limitation, the CNN 325 may output top three polygons 726 for each slice in time. The CNN 325 may then get information from the ground truth 720 as illustrated in FIG. 7C, which may indicate the top three gaps that vehicle 700 may fit into. The CNN 325 may further take these different slices 724 and predict one for the pixel where there is a polygon 726 and zero for the pixel where there is no polygon 726. The optimization may be then based on assigning a polygon 726 a very high score if the gap corresponding to such polygon 726 scores one in ground truth 720 such that the polygon 726 may be in the safe part of the volume in the ground truth 720. For the other polygons 726, the CNN 325 may try to minimize the likelihood to get the scores as close to zero as possible. Similarly, the ground truth 720 may have a lot of zero's and the error may be the difference between these low-probability polygons 726 and the ground truth 720.

In another embodiment, the optimization may be as follows. The CNN 325 may predict a 3D volume similar to the structure of the ground truth 720. The 3D volume may comprise a plurality of voxels. Each voxel may be associated with a probability. The computing system may compare each voxel in the predicted 3D volume with a corresponding ground-truth voxel during training. The computing system may further optimize the machine-learning model based on maximizing similarities between the probabilities associated with the voxels in the predicted 3D volume and values associated with the corresponding ground-truth voxels. Once the optimization is completed, one may need to post-process the outputted 3D volume to determine which voxels correspond to a gap. As an example and not by way of limitation, the post-processing may be based on clustering, i.e., voxels with high probabilities may be clustered together which may correspond to a gap. The aforementioned approach may automatically figure out how many likely goal states there may be given enough training data without the need to predetermine the number of goal states.

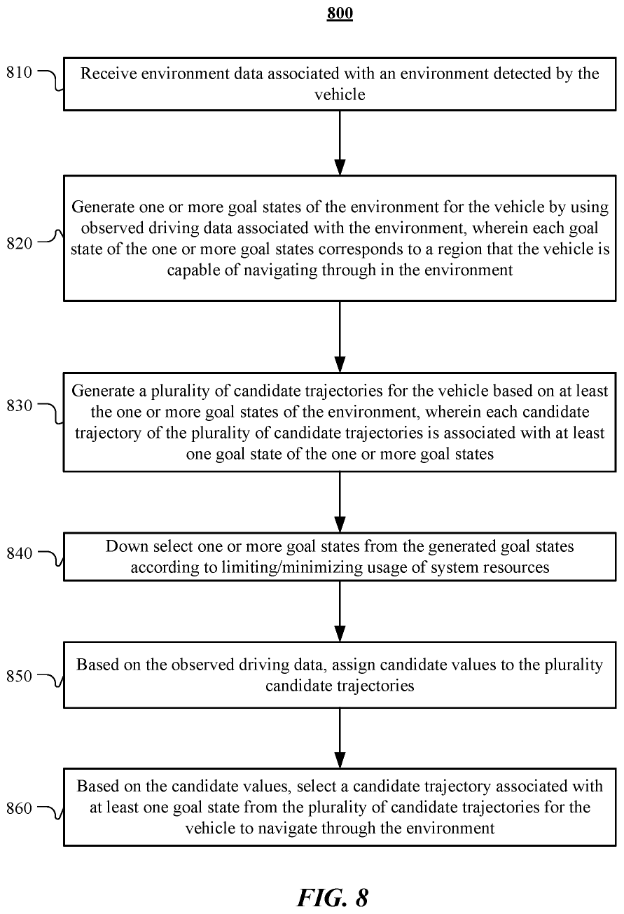

FIG. 8 illustrates an example method 800 for determining a trajectory using goal states. The method may begin at step 810, where a computing system of a vehicle may receive environment data associated with an environment detected by the vehicle. At step 820, the computing system may generate one or more goal states of the environment for the vehicle by using observed driving data associated with the environment, wherein each goal state of the one or more goal states corresponds to a region that the vehicle is capable of navigating through in the environment. At step 830, the computing system may generate a plurality of candidate trajectories for the vehicle based on at least the one or more goal states of the environment, wherein each candidate trajectory of the plurality of candidate trajectories is associated with at least one goal state of the one or more goal states. At step 840, the computing system may down select one or more goal states from the generated goal states according to limiting/minimizing usage of system resources. At step 850, the computing system may, based on the observed driving data, assign candidate values to the plurality candidate trajectories. At step 860, the computing system may, based on the candidate values, select a candidate trajectory associated with at least one goal state from the plurality of candidate trajectories for the vehicle to navigate through the environment. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for determining a trajectory using goal states including the particular steps of the method of FIG. 8, this disclosure contemplates any suitable method for determining a trajectory using goal states including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

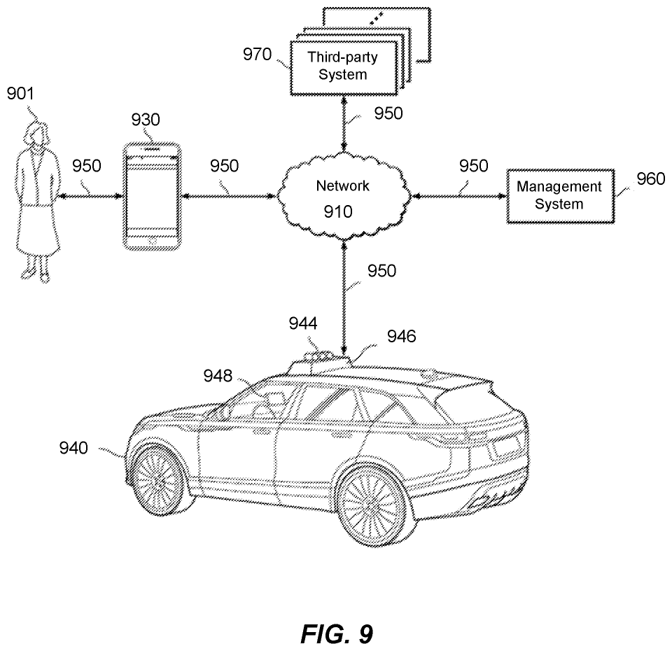

FIG. 9 illustrates an example block diagram of a transportation management environment for matching ride requestors with autonomous vehicles. In particular embodiments, the environment may include various computing entities, such as a user computing device 930 of a user 901 (e.g., a ride provider or requestor), a transportation management system 960, an autonomous vehicle 940, and one or more third-party system 970. The computing entities may be communicatively connected over any suitable network 910. As an example and not by way of limitation, one or more portions of network 910 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 9 illustrates a single user device 930, a single transportation management system 960, a single vehicle 940, a plurality of third-party systems 970, and a single network 910, this disclosure contemplates any suitable number of each of these entities. As an example and not by way of limitation, the network environment may include multiple users 901, user devices 930, transportation management systems 960, autonomous-vehicles 940, third-party systems 970, and networks 910.

The user device 930, transportation management system 960, autonomous vehicle 940, and third-party system 970 may be communicatively connected or co-located with each other in whole or in part. These computing entities may communicate via different transmission technologies and network types. For example, the user device 930 and the vehicle 940 may communicate with each other via a cable or short-range wireless communication (e.g., Bluetooth, NFC, WI-FI, etc.), and together they may be connected to the Internet via a cellular network that is accessible to either one of the devices (e.g., the user device 930 may be a smartphone with LTE connection). The transportation management system 960 and third-party system 970, on the other hand, may be connected to the Internet via their respective LAN/WLAN networks and Internet Service Providers (ISP). FIG. 9 illustrates transmission links 950 that connect user device 930, autonomous vehicle 940, transportation management system 960, and third-party system 970 to communication network 910. This disclosure contemplates any suitable transmission links 950, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof In particular embodiments, one or more links 950 may connect to one or more networks 910, which may include in part, e.g., ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 950. For example, the user device 930 may communicate with the transportation management system via a cellular network and the Internet, but communicate with the autonomous vehicle 940 via Bluetooth or a physical wire connection.

In particular embodiments, the transportation management system 960 may fulfill ride requests for one or more users 901 by dispatching suitable vehicles. The transportation management system 960 may receive any number of ride requests from any number of ride requestors 901. In particular embodiments, a ride request from a ride requestor 901 may include an identifier that identifies the ride requestor in the system 960. The transportation management system 960 may use the identifier to access and store the ride requestor's 901 information, in accordance with the requestor's 901 privacy settings. The ride requestor' s 901 information may be stored in one or more data stores (e.g., a relational database system) associated with and accessible to the transportation management system 960. In particular embodiments, ride requestor information may include profile information about a particular ride requestor 901. In particular embodiments, the ride requestor 901 may be associated with one or more categories or types, through which the ride requestor 901 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 960 may classify a user 901 based on known information about the user 901 (e.g., using machine-learning classifiers), and use the classification to retrieve relevant aggregate information associated with that class. For example, the system 960 may classify a user 901 as a young adult and retrieve relevant aggregate information associated with young adults, such as the type of music generally preferred by young adults.

Transportation management system 960 may also store and access ride information. Ride information may include locations related to the ride, traffic data, route options, optimal pick-up or drop-off locations for the ride, or any other suitable information associated with a ride. As an example and not by way of limitation, when the transportation management system 960 receives a request to travel from San Francisco International Airport (SFO) to Palo Alto, California, the system 960 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride. In particular embodiments, portions of the ride information may be based on historical data associated with historical rides facilitated by the system 960. For example, historical data may include aggregate information generated based on past ride information, which may include any ride information described herein and telemetry data collected by sensors in autonomous vehicles and/or user devices. Historical data may be associated with a particular user (e.g., that particular user's preferences, common routes, etc.), a category/class of users (e.g., based on demographics), and/or all users of the system 960. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, etc. As yet another example, historical data associated with all users may include general usage trends, such as traffic and ride patterns. Using historical data, the system 960 in particular embodiments may predict and provide ride suggestions in response to a ride request. In particular embodiments, the system 960 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and/or semi-supervised learning based on a mixture of labeled and unlabeled training data.

In particular embodiments, transportation management system 960 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 960 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or any other suitable type of database system. Although this disclosure describes or illustrates particular types of databases, this disclosure contemplates any suitable types of databases. Particular embodiments may provide interfaces that enable a user device 930 (which may belong to a ride requestor or provider), a transportation management system 960, vehicle system 940, or a third-party system 970 to process, transform, manage, retrieve, modify, add, or delete the information stored in the data store.

In particular embodiments, transportation management system 960 may include an authorization server (or any other suitable component(s)) that allows users 901 to opt-in to or opt-out of having their information and actions logged, recorded, or sensed by transportation management system 960 or shared with other systems (e.g., third-party systems 970). In particular embodiments, a user 901 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 901 of transportation management system 960 through blocking, data hashing, anonymization, or other suitable techniques as appropriate.

In particular embodiments, third-party system 970 may be a network-addressable computing system that may provide HD maps or host GPS maps, customer reviews, music or content, weather information, or any other suitable type of information. Third-party system 970 may generate, store, receive, and send relevant data, such as, for example, map data, customer review data from a customer review website, weather data, or any other suitable type of data. Third-party system 970 may be accessed by the other computing entities of the network environment either directly or via network 910. For example, user device 930 may access the third-party system 970 via network 910, or via transportation management system 960. In the latter case, if credentials are required to access the third-party system 970, the user 901 may provide such information to the transportation management system 960, which may serve as a proxy for accessing content from the third-party system 970.

In particular embodiments, user device 930 may be a mobile computing device such as a smartphone, tablet computer, or laptop computer. User device 930 may include one or more processors (e.g., CPU and/or GPU), memory, and storage. An operating system and applications may be installed on the user device 930, such as, e.g., a transportation application associated with the transportation management system 960, applications associated with third-party systems 970, and applications associated with the operating system. User device 930 may include functionality for determining its location, direction, or orientation, based on integrated sensors such as GPS, compass, gyroscope, or accelerometer. User device 930 may also include wireless transceivers for wireless communication and may support wireless communication protocols such as Bluetooth, near-field communication (NFC), infrared (IR) communication, WI-FI, and/or 2G/3G/4G/LTE mobile communication standard. User device 930 may also include one or more cameras, scanners, touchscreens, microphones, speakers, and any other suitable input-output devices.

In particular embodiments, the vehicle 940 may be an autonomous vehicle and equipped with an array of sensors 944, a navigation system 946, and a ride-service computing device 948. In particular embodiments, a fleet of autonomous vehicles 940 may be managed by the transportation management system 960. The fleet of autonomous vehicles 940, in whole or in part, may be owned by the entity associated with the transportation management system 960, or they may be owned by a third-party entity relative to the transportation management system 960. In either case, the transportation management system 960 may control the operations of the autonomous vehicles 940, including, e.g., dispatching select vehicles 940 to fulfill ride requests, instructing the vehicles 940 to perform select operations (e.g., head to a service center or charging/fueling station, pull over, stop immediately, self-diagnose, lock/unlock compartments, change music station, change temperature, and any other suitable operations), and instructing the vehicles 940 to enter select operation modes (e.g., operate normally, drive at a reduced speed, drive under the command of human operators, and any other suitable operational modes).

In particular embodiments, the autonomous vehicles 940 may receive data from and transmit data to the transportation management system 960 and the third-party system 970. Example of received data may include, e.g., instructions, new software or software updates, maps, 3D models, trained or untrained machine-learning models, location information (e.g., location of the ride requestor, the autonomous vehicle 940 itself, other autonomous vehicles 940, and target destinations such as service centers), navigation information, traffic information, weather information, entertainment content (e.g., music, video, and news) ride requestor information, ride information, and any other suitable information. Examples of data transmitted from the autonomous vehicle 940 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 940, passengers may send/receive data to the transportation management system 960 and/or third-party system 970), and any other suitable data.

In particular embodiments, autonomous vehicles 940 may also communicate with each other as well as other traditional human-driven vehicles, including those managed and not managed by the transportation management system 960. For example, one vehicle 940 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) and/or over a network (e.g., the Internet or via the transportation management system 960 or third-party system 970).

In particular embodiments, an autonomous vehicle 940 may obtain and process sensor/telemetry data. Such data may be captured by any suitable sensors. For example, the vehicle 940 may have aa Light Detection and Ranging (LiDAR) sensor array of multiple LiDAR transceivers that are configured to rotate 360°, emitting pulsed laser light and measuring the reflected light from objects surrounding vehicle 940. In particular embodiments, LiDAR transmitting signals may be steered by use of a gated light valve, which may be a MEMs device that directs a light beam using the principle of light diffraction. Such a device may not use a gimbaled mirror to steer light beams in 360° around the autonomous vehicle. Rather, the gated light valve may direct the light beam into one of several optical fibers, which may be arranged such that the light beam may be directed to many discrete positions around the autonomous vehicle. Thus, data may be captured in 360° around the autonomous vehicle, but no rotating parts may be necessary. A LiDAR is an effective sensor for measuring distances to targets, and as such may be used to generate a three-dimensional (3D) model of the external environment of the autonomous vehicle 940. As an example and not by way of limitation, the 3D model may represent the external environment including objects such as other cars, curbs, debris, objects, and pedestrians up to a maximum range of the sensor arrangement (e.g., 50, 100, or 200 meters). As another example, the autonomous vehicle 940 may have optical cameras pointing in different directions. The cameras may be used for, e.g., recognizing roads, lane markings, street signs, traffic lights, police, other vehicles, and any other visible objects of interest. To enable the vehicle 940 to “see” at night, infrared cameras may be installed. In particular embodiments, the vehicle may be equipped with stereo vision for, e.g., spotting hazards such as pedestrians or tree branches on the road. As another example, the vehicle 940 may have radars for, e.g., detecting other vehicles and/or hazards afar. Furthermore, the vehicle 940 may have ultrasound equipment for, e.g., parking and obstacle detection. In addition to sensors enabling the vehicle 940 to detect, measure, and understand the external world around it, the vehicle 940 may further be equipped with sensors for detecting and self-diagnosing the vehicle's own state and condition. For example, the vehicle 940 may have wheel sensors for, e.g., measuring velocity; global positioning system (GPS) for, e.g., determining the vehicle's current geolocation; and/or inertial measurement units, accelerometers, gyroscopes, and/or odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, an autonomous vehicle 940 may build a 3D model of its surrounding based on data from its LiDAR, radar, sonar, and cameras, along with a pre-generated map obtained from the transportation management system 960 or the third-party system 970. Although sensors 944 appear in a particular location on autonomous vehicle 940 in FIG. 9, sensors 944 may be located in any suitable location in or on autonomous vehicle 940. Example locations for sensors include the front and rear bumpers, the doors, the front windshield, on the side panel, or any other suitable location.

In particular embodiments, the autonomous vehicle 940 may be equipped with a processing unit (e.g., one or more CPUs and GPUs), memory, and storage. The vehicle 940 may thus be equipped to perform a variety of computational and processing tasks, including processing the sensor data, extracting useful information, and operating accordingly. For example, based on images captured by its cameras and a machine-vision model, the vehicle 940 may identify particular types of objects captured by the images, such as pedestrians, other vehicles, lanes, curbs, and any other objects of interest.

In particular embodiments, the autonomous vehicle 940 may have a navigation system 946 responsible for safely navigating the autonomous vehicle 940. In particular embodiments, the navigation system 946 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 946 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system 946 may use its determinations to control the vehicle 940 to operate in prescribed manners and to guide the autonomous vehicle 940 to its destinations without colliding into other objects. Although the physical embodiment of the navigation system 946 (e.g., the processing unit) appears in a particular location on autonomous vehicle 940 in FIG. 9, navigation system 946 may be located in any suitable location in or on autonomous vehicle 940. Example locations for navigation system 946 include inside the cabin or passenger compartment of autonomous vehicle 940, near the engine/battery, near the front seats, rear seats, or in any other suitable location.

In particular embodiments, the autonomous vehicle 940 may be equipped with a ride-service computing device 948, which may be a tablet or any other suitable device installed by transportation management system 960 to allow the user to interact with the autonomous vehicle 940, transportation management system 960, other users 901, or third-party systems 970. In particular embodiments, installation of ride-service computing device 948 may be accomplished by placing the ride-service computing device 948 inside autonomous vehicle 940, and configuring it to communicate with the vehicle 940 via a wire or wireless connection (e.g., via Bluetooth). Although FIG. 9 illustrates a single ride-service computing device 948 at a particular location in autonomous vehicle 940, autonomous vehicle 940 may include several ride-service computing devices 948 in several different locations within the vehicle. As an example and not by way of limitation, autonomous vehicle 940 may include four ride-service computing devices 948 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 948 may be detachable from any component of autonomous vehicle 940. This may allow users to handle ride-service computing device 948 in a manner consistent with other tablet computing devices. As an example and not by way of limitation, a user may move ride-service computing device 948 to any location in the cabin or passenger compartment of autonomous vehicle 940, may hold ride-service computing device 948, or handle ride-service computing device 948 in any other suitable manner. Although this disclosure describes providing a particular computing device in a particular manner, this disclosure contemplates providing any suitable computing device in any suitable manner.

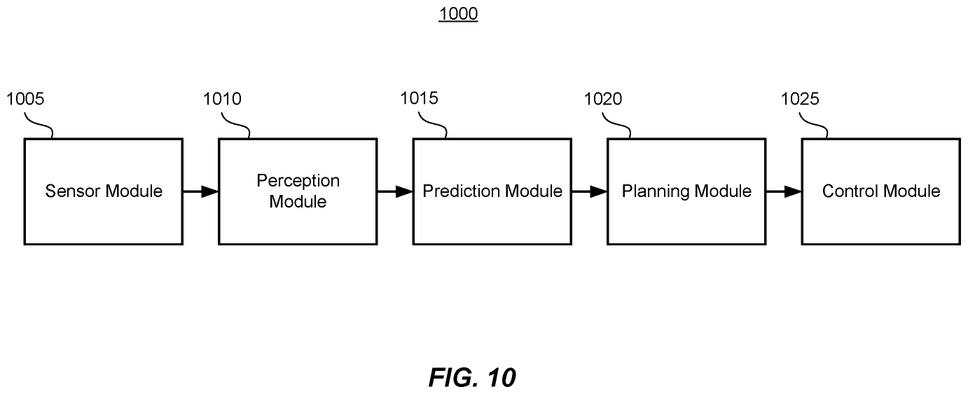

FIG. 10 illustrates an example block diagram of an algorithmic navigation pipeline. In particular embodiments, an algorithmic navigation pipeline 1000 may include a number of computing modules, such as a sensor data module 1005, perception module 1010, prediction module 1015, planning module 1020, and control module 1025. Sensor data module 1005 may obtain and pre-process sensor/telemetry data that is provided to perception module 1010. Such data may be captured by any suitable sensors of a vehicle. As an example and not by way of limitation, the vehicle may have a Light Detection and Ranging (LiDAR) sensor that is configured to transmit pulsed laser beams in multiple directions and measure the reflected signal from objects surrounding vehicle. The time of flight of the light signals may be used to measure the distance or depth of the objects from the LiDAR.. As another example, the vehicle may have optical cameras pointing in different directions to capture images of the vehicle's surrounding. Radars may also be used by the vehicle for detecting other vehicles and/or hazards at a distance. As further examples, the vehicle may be equipped with ultrasound for close range object detection, e.g., parking and obstacle detection or infrared cameras for object detection in low-light situations or darkness. In particular embodiments, sensor data module 1005 may suppress noise in the sensor data or normalize the sensor data.

[53] Perception module 1010 is responsible for correlating and fusing the data from the different types of sensors of the sensor module 1005 to model the contextual environment of the vehicle. Perception module 1010 may use information extracted by multiple independent sensors to provide information that would not be available from any single type of sensors. Combining data from multiple sensor types allows the perception module 1010 to leverage the strengths of different sensors and more accurately and precisely perceive the environment. As an example and not by way of limitation, image-based object recognition may not work well in low-light conditions. This may be compensated by sensor data from LiDAR or radar, which are effective sensors for measuring distances to targets in low-light conditions. As another example, image-based object recognition may mistakenly determine that an object depicted in a poster is an actual three-dimensional object in the environment. However, if depth information from a LiDAR is also available, the perception module 1010 could use that additional information to determine that the object in the poster is not, in fact, a three-dimensional object.

Perception module 1010 may process the available data (e.g., sensor data, data from a high-definition map, etc.) to derive information about the contextual environment. For example, perception module 1010 may include one or more agent modelers (e.g., object detectors, object classifiers, or machine-learning models trained to derive information from the sensor data) to detect and/or classify agents present in the environment of the vehicle (e.g., other vehicles, pedestrians, moving objects). Perception module 1010 may also determine various characteristics of the agents. For example, perception module 1010 may track the velocities, moving directions, accelerations, trajectories, relative distances, or relative positions of these agents. In particular embodiments, the perception module 1010 may also leverage information from a high-definition map. The high-definition map may include a precise three-dimensional model of the environment, including buildings, curbs, street signs, traffic lights, and any stationary fixtures in the environment. Using the vehicle's GPS data and/or image-based localization techniques (e.g., simultaneous localization and mapping, or SLAM), the perception module 1010 could determine the pose (e.g., position and orientation) of the vehicle or the poses of the vehicle's sensors within the high-definition map. The pose information, in turn, may be used by the perception module 1010 to query the high-definition map and determine what objects are expected to be in the environment.

Perception module 1010 may use the sensor data from one or more types of sensors and/or information derived therefrom to generate a representation of the contextual environment of the vehicle. As an example and not by way of limitation, the representation of the external environment may include objects such as other vehicles, curbs, debris, objects, and pedestrians. The contextual representation may be limited to a maximum range of the sensor array (e.g., 50, 100, or 200 meters). The representation of the contextual environment may include information about the agents and objects surrounding the vehicle, as well as semantic information about the traffic lanes, traffic rules, traffic signs, time of day, weather, and/or any other suitable information. The contextual environment may be represented in any suitable manner. As an example and not by way of limitation, the contextual representation may be encoded as a vector or matrix of numerical values, with each value in the vector/matrix corresponding to a predetermined category of information. For example, each agent in the environment may be represented by a sequence of values, starting with the agent's coordinate, classification (e.g., vehicle, pedestrian, etc.), orientation, velocity, trajectory, and so on. Alternatively, information about the contextual environment may be represented by a raster image that visually depicts the agent, semantic information, etc. For example, the raster image may be a birds-eye view of the vehicle and its surrounding, up to a predetermined distance. The raster image may include visual information (e.g., bounding boxes, color-coded shapes, etc.) that represent various data of interest (e.g., vehicles, pedestrians, lanes, buildings, etc.).

The representation of the present contextual environment from the perception module 1010 may be consumed by a prediction module 1015 to generate one or more predictions of the future environment. For example, given a representation of the contextual environment at time to, the prediction module 1015 may output another contextual representation for time ti. For instance, if the to contextual environment is represented by a raster image, the output of the prediction module 1015 may be another raster image (e.g., a snapshot of the current environment) that depicts where the agents would be at time ti (e.g., a snapshot of the future). In particular embodiments, prediction module 1015 may include a machine-learning model (e.g., a convolutional neural network, a neural network, a decision tree, support vector machines, etc.) that may be trained based on previously recorded contextual and sensor data. For example, one training sample may be generated based on a sequence of actual sensor data captured by a vehicle at times t₀ and t₁. The captured data at times to and ti may be used to generate, respectively, a first contextual representation (the training data) and a second contextual representation (the associated ground-truth used for training). During training, the machine-learning model may process the first contextual representation using the model's current configuration parameters and output a predicted contextual representation. The predicted contextual representation may then be compared to the known second contextual representation (i.e., the ground-truth at time t₁). The comparison may be quantified by a loss value, computed using a loss function. The loss value may be used (e.g., via back-propagation techniques) to update the configuration parameters of the machine-learning model so that the loss would be less if the prediction were to be made again. The machine-learning model may be trained iteratively using a large set of training samples until a convergence or termination condition is met. For example, training may terminate when the loss value is below a predetermined threshold. Once trained, the machine-learning model may be used to generate predictions of future contextual representations based on current contextual representations.

Planning module 1020 may determine the navigation routes and particular driving operations (e.g., slowing down, speeding up, stopping, swerving, etc.) of the vehicle based on the predicted contextual representation generated by the prediction module 1015. In particular embodiments, planning module 1020 may utilize the predicted information encoded within the predicted contextual representation (e.g., predicted location or trajectory of agents, semantic data, etc.) and any other available information (e.g., map data, traffic data, accident reports, weather reports, target destinations, and any other suitable information) to determine one or more goals or navigation instructions for the vehicle. As an example and not by way of limitation, based on the predicted behavior of the agents surrounding the vehicle and the traffic data to a particular destination, planning module 1020 may determine a particular navigation path and associated driving operations for the vehicle to avoid possible collisions with one or more agents. In particular embodiments, planning module 1020 may generate, based on a given predicted contextual presentation, several different plans (e.g., goals or navigation instructions) for the vehicle. For each plan, the planning module 1020 may compute a score that represents the desirability of that plan. For example, if the plan would likely result in the vehicle colliding with an agent at a predicted location for that agent, as determined based on the predicted contextual representation, the score for the plan may be penalized accordingly. Another plan that would cause the vehicle to violate traffic rules or take a lengthy detour to avoid possible collisions may also have a score that is penalized, but the penalty may be less severe than the penalty applied for the previous plan that would result in collision. A third plan that causes the vehicle to simply stop or change lanes to avoid colliding with the agent in the predicted future may receive the highest score. Based on the assigned scores for the plans, the planning module 1020 may select the best plan to carry out. While the example above used collision as an example, the disclosure herein contemplates the use of any suitable scoring criteria, such as travel distance or time, fuel economy, changes to the estimated time of arrival at the destination, passenger comfort, proximity to other vehicles, the confidence score associated with the predicted contextual representation, etc.

Based on the plan generated by planning module 1020, which may include one or more navigation path or associated driving operations, control module 1025 may determine the specific commands to be issued to the actuators of the vehicle. The actuators of the vehicle are components that are responsible for moving and controlling the vehicle. The actuators control driving functions of the vehicle, such as for example, steering, turn signals, deceleration (braking), acceleration, gear shift, etc. As an example and not by way of limitation, control module 1025 may transmit commands to a steering actuator to maintain a particular steering angle for a particular amount of time to move a vehicle on a particular trajectory to avoid agents predicted to encroach into the area of the vehicle. As another example, control module 1025 may transmit commands to an accelerator actuator to have the vehicle safely avoid agents predicted to encroach into the area of the vehicle.

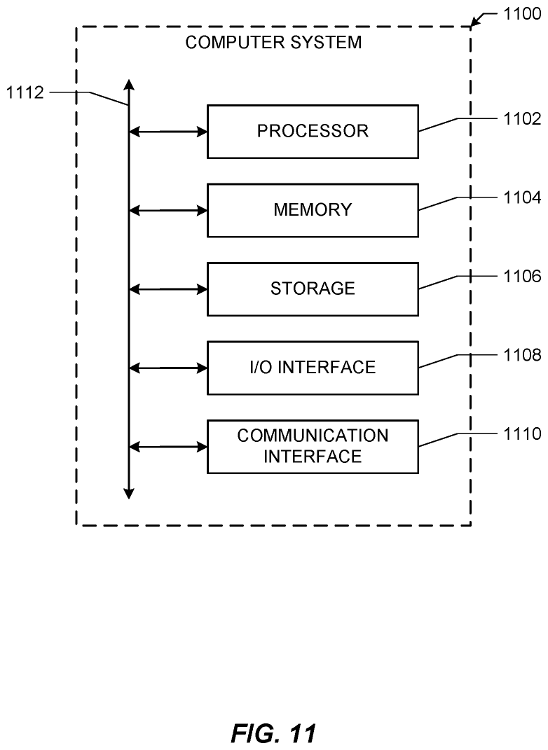

FIG. 11 illustrates an example computer system 1100. In particular embodiments, one or more computer systems 1100 perform one or more steps of one or more methods described or illustrated herein. In particular embodiments, one or more computer systems 1100 provide the functionalities described or illustrated herein. In particular embodiments, software running on one or more computer systems 1100 performs one or more steps of one or more methods described or illustrated herein or provides the functionalities described or illustrated herein. Particular embodiments include one or more portions of one or more computer systems 1100. Herein, a reference to a computer system may encompass a computing device, and vice versa, where appropriate. Moreover, a reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 that are to be operated on by computer instructions; the results of previous instructions executed by processor 1102 that are accessible to subsequent instructions or for writing to memory 1104 or storage 1106; or any other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs), be a multi-core processor, or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described in further detail below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system of a vehicle:
receiving environment data associated with an environment detected by the vehicle;
generating one or more goal states of the environment for the vehicle by using observed driving data associated with the environment, wherein each goal state of the one or more goal states corresponds to a region that the vehicle is capable of navigating through in the environment;
generating a plurality of candidate trajectories for the vehicle based on at least the one or more goal states of the environment, wherein each candidate trajectory of the plurality of candidate trajectories is associated with at least one goal state of the one or more goal states;
based on the observed driving data, assigning candidate values to the plurality candidate trajectories; and
based on the candidate values, selecting a candidate trajectory associated with at least one goal state from the plurality of candidate trajectories for the vehicle to navigate through the environment.

2. The method of claim 1, further comprising:
determining one or more global driving constraints based on the environment data; and
determining one or more conditional driving constraints for each of the one or more goal states.

3. The method of claim 2, wherein assigning a candidate value of the candidate values to each candidate trajectory of the plurality candidate trajectories is further based on at least one of the one or more global driving constraints or the one or more conditional driving constraints.

4. The method of claim 1, wherein generating the one or more goal states of the environment for the vehicle is based on a machine-learning model, wherein the machine-learning model is trained based on a plurality of training data indicative of driving behaviors, wherein the plurality of training data indicative of driving behaviors comprise captured sensor data comprising at least one of images, videos, LiDAR point clouds, radar signals, or any combination thereof

5. The method of claim 4, further comprising training the machine-learning model, wherein the training comprises:
predicting a predetermined number of polygons for a two-dimensional (2D) spatial output corresponding to the environment at a discrete time within the time period, wherein each polygon is associated with a probability;
comparing the 2D spatial output with a ground-truth 2D spatial data at the discrete time;
identifying a correct polygon from the predicted polygons; and
optimizing the machine-learning model based on maximizing the probability of the correct polygon and minimizing the probabilities of the remaining predicted polygons.

6. The method of claim 4, further comprising training the machine-learning model, wherein the training comprises:
predicting a 3D volume comprising a plurality of voxels, wherein each voxel is associated with a probability;
comparing each voxel in the predicted 3D volume with a corresponding ground-truth voxel; and
optimizing the machine-learning model based on maximizing similarities between the probabilities associated with the voxels in the predicted 3D volume and values associated with the corresponding ground-truth voxels.

7. The method of claim 1, wherein the one or more goal states represent at least one of an intermediate or a terminal goal state, and wherein the intermediate goal state can be used to reach the terminal goal state.

8. The method of claim 1, further comprising down selecting one or more goal states from the generated one or more goal states, wherein the down selection comprises:
predicting a probability heat map for the one or more agents based on a prediction of an evolution of the environment , wherein the one or more goal states from the goal states are based on the probability heat map.

9. The method of claim 1, wherein assigning candidate values to the plurality of candidate trajectories comprises:
determining one or more respective characteristics for each of the plurality of candidate trajectories; and
calculating a candidate value for each of the plurality of candidate trajectories based on the one or more respective characteristics and the at least one goal state associated with the candidate traj ectory.

10. The method of claim 9, wherein the characteristics comprise one or more of:
a distance of a candidate trajectory to an obstacle;
an acceleration associated with a candidate trajectory;
comfort characteristics associated with a candidate trajectory; or
safety characteristics associated with a candidate trajectory.

11. The method of claim 1, further comprising:
generating a raster of the environment based on the environment data, wherein generating the one or more goal states of the environment for the vehicle is further based on the raster of the environment.

12. The method of claim 11, wherein the raster is based on the environment at a current time or a prediction of the environment at a future time.

13. The method of claim 11, wherein generating the raster of the environment based on the environment data comprises rasterizing one or more top-down images of the vehicle and agents around the vehicle in the environment.

14. The method of claim 1, wherein the environment data comprises information comprising one or more of:
distances between the vehicle and agents around the vehicle in the environment;
lane boundaries associated with the environment;
velocities of the vehicle and the agents;
driving directions of the vehicle and the agents;
yield relationships between the vehicle and the agents;
locations of the vehicle and the agents;
positional relationship between the vehicle and the agents; or cost associated with potential lane changing for the vehicle.

15. A system comprising: one or more processors and one or more computer-readable non-transitory storage media, the one or more computer-readable non-transitory storage media comprising instructions operable when executed by the one or more processors to cause the system to perform operations comprising:
receiving environment data associated with an environment detected by the vehicle;
generating one or more goal states of the environment for the vehicle by using observed driving data associated with the environment, wherein each goal state of the one or more goal states corresponds to a region that the vehicle is capable of navigating through in the environment;
generating a plurality of candidate trajectories for the vehicle based on at least the one or more goal states of the environment, wherein each candidate trajectory of the plurality of candidate trajectories is associated with at least one goal state of the one or more goal states;
based on the observed driving data, assigning candidate values to the plurality candidate trajectories; and
based on the candidate values, selecting a candidate trajectory associated with at least one goal state from the plurality of candidate trajectories for the vehicle to navigate through the environment.

16. The system of claim 15, wherein the one or more processors are further operable when executing the instructions to perform operations comprising:
determining one or more global driving constraints based on the environment data; and
determining one or more conditional driving constraints for each of the one or more goal states.

17. The system of claim 16, wherein assigning a candidate value of the candidate values to each candidate trajectory of the plurality candidate trajectories is further based on at least one of the one or more global driving constraints or the one or more conditional driving constraints.

18. One or more computer-readable non-transitory storage media including instructions that, when executed by one or more processors, are configured to cause the one or more processors to perform operations comprising:
receiving environment data associated with an environment detected by the vehicle;
generating one or more goal states of the environment for the vehicle by using observed driving data associated with the environment, wherein each goal state of the one or more goal states corresponds to a region that the vehicle is capable of navigating through in the environment;
generating a plurality of candidate trajectories for the vehicle based on at least the one or more goal states of the environment, wherein each candidate trajectory of the plurality of candidate trajectories is associated with at least one goal state of the one or more goal states;
based on the observed driving data, assigning candidate values to the plurality candidate trajectories; and
based on the candidate values, selecting a candidate trajectory associated with at least one goal state from the plurality of candidate trajectories for the vehicle to navigate through the environment.

19. The media of claim 18, wherein the instructions are further configured to cause the one or more processors to perform further operations comprising:
determining one or more global driving constraints based on the environment data; and
determining one or more conditional driving constraints for each of the one or more goal states.

20. The media of claim 18, wherein assigning a candidate value of the candidate values to each candidate trajectory of the plurality candidate trajectories is further based on at least one of the one or more global driving constraints or the one or more conditional driving constraints.
